(19) United States
(12) Patent Application Publication
(10) Pub. No.: US 2018/0170110 A1
(43) Pub. Date: Jun. 21, 2018

(54) PNEUMATIC TIRE HAVING A SINGLE CARCASS PLY REINFORCED WITH STEEL CORDS

(71) Applicant: The Goodyear Tire & Rubber Company, Akron, OH (US)

(72) Inventors: Etienne SCHAUER, Welsdorf (LU); Robert Edward LIONETTI, Bereldange (LU); Arun Prasath MANOGARAN, Colmar-berg (LU); Boris ERCEG, Hanau (DE); Soundappan RAMANATHAN, Langen (Hessen) (DE)

(21) Appl. No.: 15/384,686

(22) Filed: Dec. 20, 2016

(51) Int. Cl. B60C 9/02; B60C 9/00; B60C 15/06; B60C 15/04; B60C 15/00

(52) U.S. Cl. CPC B60C 9/02; B60C 9/0007; B60C 15/0603; B60C 15/0632; B60C 2009/0425; B60C 15/0635; B60C 15/0036; B60C 2015/0614; B60C 15/04

(57) ABSTRACT

A pneumatic tire includes a pair of beads each with an associated bead core and chafer, a single carcass ply folded about each bead so as to define a main body portion and a turnup portion associated with each bead, and a tread disposed radially outward from the single carcass ply, the tread having shoulder portions disposed at axial outer edges of the tread; and a pair of sidewalls extending radially outward from each chafer to a location adjacent each shoulder portion, each sidewall being disposed axially outward of the single carcass ply. The single carcass ply is reinforced with metallic cords, the metallic cords comprising filaments with diameters from 0.10 mm to 0.12 mm

### FIELD OF THE PRESENT INVENTION

The present invention relates to a pneumatic tire having a single carcass reinforced with high strength metallic cords.

### BACKGROUND OF THE INVENTION

One conventional pneumatic tire includes a carcass ply having a main portion that extends between both bead cores of the tire and turnup portions that are anchored around each bead core. The radially outer edges of the turnup portions of the carcass ply are disposed radially outward of the bead cores a minimal distance and are in contact with the main portion of the carcass ply. Suitable elastomeric materials surround the bead core, carcass ply and other elastomeric components to complete the bead portion of the tire. A clamping member includes a strip of side-by-side cords of a heat shrinkable material embedded in a suitable elastomeric substance having a permanent thermal shrinkage of at least 2 percent. This strip of cords is extended from a location radially and axially inward of the bead core to a location radially outward of the bead core with no filler strip or apex disposed between the main portion and turnup portion of the carcass ply. The heat shrinkable material may be 1260/2 Nylon 6,6 having a permanent thermal shrinkage of about 4 percent. It is a continual overriding goal to simplify the construction and reduce the expense of building tires, yet improve the durability, handling, rolling resistance, and other properties of the pneumatic tires.

Another conventional pneumatic tire has a pair of axially spaced annular bead cores and a single carcass ply which is folded about each bead core. Each bead core includes a plurality of wraps of a single metallic filament. The single carcass ply is reinforced with parallel metallic cords composed of at least one filament having a tensile strength of at least (−2000×D+4400 MPa)×95%, where D is the filament diameter in millimeters. The single carcass ply is folded about each bead core. The single carcass ply has a main portion that extends between the bead cores and turnup portions that are folded around the bead cores. A radially outer edge of each turnup portion is in contact with the main portion of the carcass ply and extends to an end point 0.5 inches (12.7 mm) to 4.0 inches (101.6 mm) radially outward of the bead core, as measured along the main portion of the carcass ply of the tire. No bead apex or filler is present between the carcass turnup and the main portion of the carcass ply. A toe guard associated with each bead has each end (first and second) of the toe guard being disposed directly adjacent to the carcass ply. One (the first) end is located on the axially inner side of the main portion of the carcass ply at a location about 0.4 to 3.5 inch(s) (10 mm to 89 mm) radially outward of the bead core as measured along the main portion of the carcass ply. The other, or second, end of the toe guard is located at a point ranging from substantially the axially outermost point of the bead core to a location about 3.5 inches (89 mm) radially outward of the bead core as measured along the turnup portion of the carcass ply. The first end and the second end of the toe guard is a shorter radial distance from said bead core than the end point of the turnup radial portion of the carcass ply. The respective turnup portion of the carcass ply is directly adjacent to both the toe guard and the bead core.

### SUMMARY OF THE INVENTION

A pneumatic tire in accordance with the present invention includes a pair of beads each with an associated bead core and chafer, a single carcass ply folded about each bead so as to define a main body portion and a turnup portion associated with each bead, and a tread disposed radially outward from the single carcass ply, the tread having shoulder portions disposed at axial outer edges of the tread; and a pair of sidewalls extending radially outward from each chafer to a location adjacent each shoulder portion, each sidewall being disposed axially outward of the single carcass ply. The single carcass ply is reinforced with metallic cords, the metallic cords comprising filaments with diameters from 0.10 mm to 0.12 mm.

According to another aspect of the pneumatic tire, the metallic cords comprise steel filaments.

According to still another aspect of the pneumatic tire, an apex stiffens the areas adjacent the bead cores.

According to yet another aspect of the pneumatic tire, a chipper stiffens the areas adjacent the bead cores.

According to still another aspect of the pneumatic tire, a flipper for stiffens the areas adjacent the bead cores.

According to yet another aspect of the pneumatic tire, the bead cord has a radial cross-sectional shape selected from the group consisting of substantially pentagonal, hexagonal, rectangular, and circular.

According to still another aspect of the pneumatic tire, the turnup portions are in contact with the main portion and extend to an end point radially outward of the bead core, as measured along the main portion of the single carcass ply.

According to yet another aspect of the pneumatic tire, a toe guard is disposed on an axially inner side of the main portion of the single carcass ply at a location radially outward of the bead core.

According to still another aspect of the pneumatic tire, an end of the toe guard is disposed at a point ranging from substantially the axially outermost point of the bead core to a location radially outward of the bead core, as measured along the turnup portion of the single carcass ply.

A method improves a pneumatic tire. The method includes the steps of: folding a single carcass ply about a pair of beads so as to define a main body portion and a turnup portion associated with each bead; placing a tread radially outward from the single carcass ply; extending a pair of sidewalls radially outward from a pair of chafers to a location adjacent a shoulder portion of the tread; and reinforcing the single carcass ply with steel cords having filaments with diameters from 0.10 mm to 0.12 mm.

### BRIEF DESCRIPTION OF THE DRAWINGS

The invention will be described by way of example and with reference to the accompanying drawings, in which:

FIG. 1 is a partial schematic cross-sectional view of a pneumatic tire in accordance with the present invention;

FIG. 2 is a schematic cross-sectional view of the bead portion of the pneumatic tire of FIG. 1 mounted upon a rim;

FIG. 3 is a Table of Example Cost Saving produced by the present invention; and

FIG. 4 is a Table of Example Performance/Cost Alignment produced by the present invention.

### DEFINITIONS

The following definitions are controlling for the present invention.

“Apex” means an elastomeric filler located radially above the bead core and between the plies and the turnup ply.

“Annular” means formed like a ring.

“Aspect ratio” means the ratio of its section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements, such as flippers, chippers, apexes, toe guards, and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25 degrees-65 degrees with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” or “Linear Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.2 mm filament diameter.

“Inboard side” means the side of the tire nearest the vehicle when the tire is mounted on a wheel and the wheel is mounted on the vehicle.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.2 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.2 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65 degrees and 90 degrees with respect to the equatorial plane of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.2 mm filament diameter.

“Tenacity” is stress expressed as force per unit linear density of the unstrained specimen (gmAex or gm/denier). This is used for textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (e.g., radially outward) from the beads about which the ply is wrapped.

“Ultra Tensile Steel (UT)” means a carbon steel with a tensile strength of at least 4000 MPa at 0.2 mm filament diameter.

“Vertical Deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### DETAILED DESCRIPTION OF EXAMPLES OF THE PRESENT INVENTION

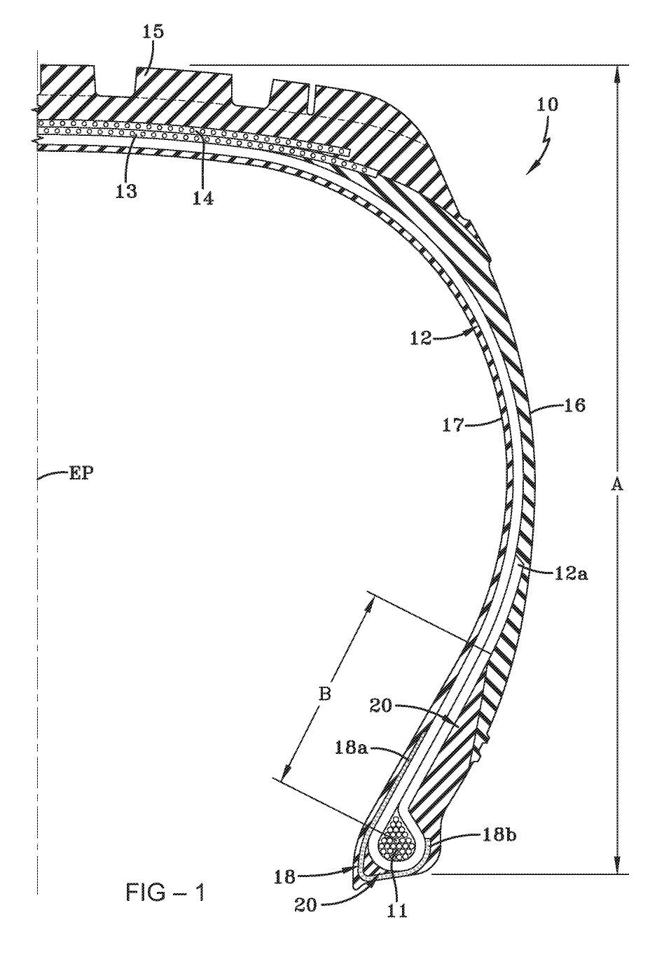

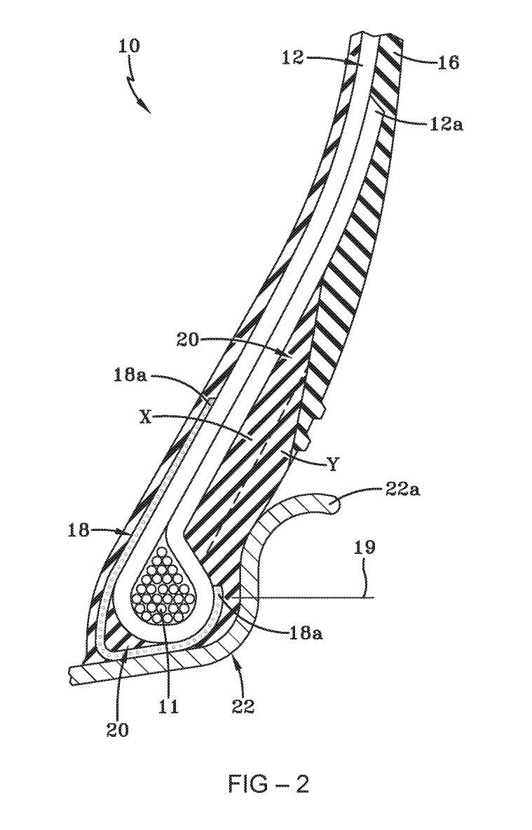

Referring now to FIGS. 1-2, there is shown a cross-sectional view of an example pneumatic tire 10 for use with the present invention and an enlarged fragmentary view of a bead portion and lower sidewall of the pneumatic tire 10 mounted upon a rim.

The pneumatic tire 10 may have a pair of bead cores 11 (only one shown), each comprising a plurality of metallic filaments. The pneumatic tire 10 may have a single carcass ply 12 extending between the bead cores 11 and a turnup portion anchored around each bead core 11. A belt structure may have at least two belts 13, 14 disposed radially outward of the main portion of the carcass ply and a ground engaging tread portion 15 disposed radially outward of the belt structure. Sidewall portions 16 (one shown) may extend radially inward from the tread portion 15 to the bead portions. On the axially inner side of the carcass ply 12, an air-impermeable innerliner 17 may be used. The innerliner 17 may have a layer or layers of elastomer or other material that form an inside surface of the pneumatic tire 10 and contain the inflating fluid, such as air, within the pneumatic tire. Additional barriers, reinforcement strips, or gum strips (not shown) may be placed at suitable locations between the innerliner 17 and main portion of the carcass ply 12 to avoid penetration of rubber through the carcass ply, especially during curing of the pneumatic tire 10.

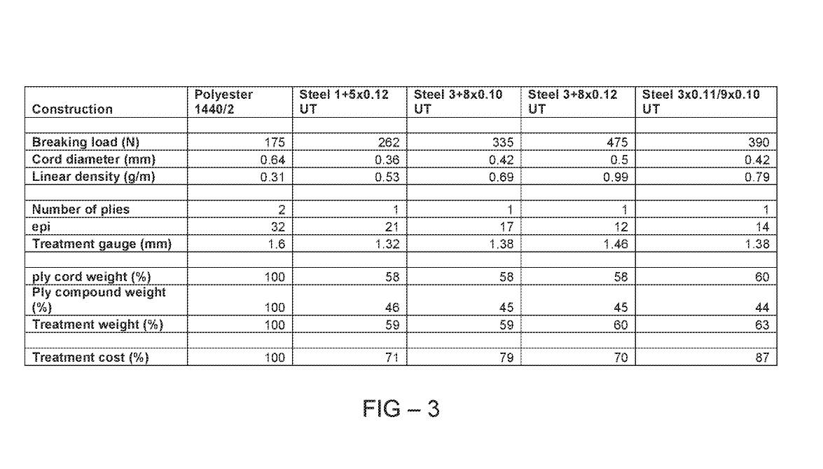

In accordance with the present invention, use of steel cords for reinforcing the carcass ply 12 in passenger tires may permit replacement of a conventional 2-ply fabric ply by a single steel-reinforced ply. The steel cords may be ultra-tensile steel with filament diameters less than 0.15 mm (e.g., 0.10 mm to 0.12 mm). Benefits of this replacement may include increased durability, decreased weight, decreased rolling resistance, and/or decreased material cost and assembly time. Moreover, because of the higher stiffness of steel cords compared to polyester fabric, cornering stiffness may also be increased. FIG. 3 shows cost savings for some example steel cord constructions. FIG. 4 shows performance versus cost aligment.

One aspect of the present invention is the single ply carcass construction reinforced with parallel metallic cords composed of the above-described filaments. There are a number of metallurgical embodiments which result in the tensile strength defined above. One way of achieving such strength is by merging the proper process and alloys, as disclosed in U.S. Pat. Nos. 4,960,473 and 5,066,455, which are hereby incorporated by reference in their entirety herein, with a steel rod microalloyed with one or more of the following elements: Ni, Fe, Cr, Nb, Si, Mo, Mn, Cu, Co, V and B. An example chemistry is listed below in weight percentages:
C 0.88 to 1.0
Mn 0.30 to 0.05
Si 0.10 to 0.3
Cr 0 to 0.4
V 0 to 0.1
Cu 0 to 0.5
Ni 0 to 0.5
Co 0 to 0.1
   with the balance being iron and residuals. The resulting rod is then drawn to the appropriate tensile strength.

For equal filament diameters, the cords used in the present invention may have higher strength and generally higher fatigue life over conventional tensile cords. These advantages lead to pneumatic tires which have less reinforcement material and thus lower weight and cost. Further the life of the tire may be increased with the increase in fatigue life of the steel cord and its filaments. When cord structures incorporate filaments having a smaller diameter, there is a resulting reduction in gauge material and cost as compared with the high or super tensile strengths making the tires lighter in weight and less costly.

The cords for use in the single ply carcass ply 12 may comprise from one (monofilament) to multiple filaments. The number of total filaments in the cord may range from 1 to 13. The number of filaments per cord may range from 6 to 7. The individual diameter (D) of each filament may generally range from 0.10 mm to 0.12 mm for each filament having at least a tensile strength of (−2000×D+4400)×95% where D is the filament diameter in mm

Another property of the steel cord may be the total elongation for each filament in the cord must be at least 2 percent over a gauge length of 25 cm. Total elongation may be measured according to ASTM A370-92. Total elongation of the cord may range from about 2 percent to about 4 percent or from about 2.2 to about 3.0.

The torsion values for the steel used in the cord may be at least 20 turns with a gauge length of 200 times the diameter of the filament wire. Generally, the torsion value ranges from about 20 to about 100 turns. The torsion values may range from about 30 turns to about 80 turns or from about 35 turns to about 65 turns. The torsion values may be determined according to ASTM Test Method E 558-83 with test lengths of 200 times the diameter of the filament wire.

There are a number of example metallic cord constructions for use in the single carcass ply. Representative examples may include 1x, 2x, 3x, 4x, 5x, 6x, 7x, 8x, 11x, 12x, 1+2, 1+4, 1+5, 1+6, 1+7, 1+8, 2+3+1, 5+1, 6+1, 11+1, 12+1, 2+7, 2+7+1, 3+9, 1+5+1, 1+6+1, and/or 3+9+1. An outer wrap filament may have a tensile strength of 2500 MPa or greater based on a filament diameter of 0.15 mm. Other conventional constructions have included 3×0.18, 1+5×0.18, 1+6×0.18, 2+7×0.18, 2+7×0.18×1×0.15, 3+9×0.18+1×0.15, 3+9×0.18, 3×0.20+9×0.18, and 0×0.20+9×0.18+1×0.15. The above cord designations are understandable to those skilled in the art. For example, a designation such as 2x, 3x, or 4x means a “bunch” of filaments; e.g., two filaments, three filaments, four filaments, etc. A designation such as 1+2 and 1+4 may indicate, for example, a single filament wrapped by two or four filaments.

The carcass ply 12 may have a layer of the above-described steel cords arranged so as to have from about 5 to about 70 ends per inch, or 2 to 28 ends per cm, when measured at the equatorial plane of the tire. The layer of cords are arranged so as to have about 7 to about 20 ends per inch, or 2.7 to about 8.0 ends per cm) at the equatorial plane. The above calculations for ends per inch may be based upon the range of diameters for the cord, strength of the cord, and the practical strength requirement for the carcass ply 12. For example, the high number of ends per inch may include the use of a lower diameter cord for a given strength versus a lower number of ends per inch for a higher diameter filament wire for the same strength. Alternatively, if one elects to use a cord of a given diameter, one may use more or less ends per inch depending on the strength of the cord. The metallic cords of the carcass ply 12 may be oriented such that a tire according to the present invention is termed a “radial”. Example steel cords of the carcass ply 12 may intersect the equatorial plane (EP) of the tire at an angle in the range from 75 degrees to 105 degrees or from 82 degrees to 98 degrees or from 89 degrees to 91 degrees.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A pneumatic tire comprising:
a pair of beads each with an associated bead core and chafer;
a single carcass ply folded about each bead so as to define a main body portion and a turnup portion associated with each bead; and
a tread disposed radially outward from the single carcass ply, the tread having shoulder portions disposed at axial outer edges of the tread; and a pair of sidewalls extending radially outward from each chafer to a location adjacent each shoulder portion, each sidewall being disposed axially outward of the single carcass ply,
the single carcass ply being reinforced with metallic cords, the metallic cords comprising filaments with diameters from 0.10 mm to 0.12 mm.

2. The pneumatic tire as set forth in claim 1 wherein the metallic cords comprise steel filaments.

3. The pneumatic tire as set forth in claim 1 further including an apex for stiffening the areas adjacent the bead cores.

4. The pneumatic tire as set forth in claim 1 further including a chipper for stiffening the areas adjacent the bead cores.

5. The pneumatic tire as set forth in claim 1 further including a flipper for stiffening the areas adjacent the bead cores.

6. The pneumatic tire as set forth in claim 1 wherein the bead cord has a radial cross-sectional shape selected from the group consisting of substantially pentagonal, hexagonal, rectangular, and circular.

7. The pneumatic tire as set forth in claim 1 wherein the turnup portions are in contact with the main portion and extend to an end point radially outward of the bead core, as measured along the main portion of the single carcass ply.

8. The pneumatic tire as set forth in claim 1 further including a toe guard disposed on an axially inner side of the main portion of the single carcass ply at a location radially outward of the bead core.

9. The pneumatic tire as set forth in claim 8 wherein an end of the toe guard is disposed at a point ranging from substantially the axially outermost point of the bead core to a location radially outward of the bead core, as measured along the turnup portion of the single carcass ply.

10. A method for improving a pneumatic tire, the method including the steps of:
folding a single carcass ply about a pair of beads so as to define a main body portion and a turnup portion associated with each bead;
placing a tread radially outward from the single carcass ply;
extending a pair of sidewalls radially outward from a pair of chafers to a location adjacent a shoulder portion of the tread; and
reinforcing the single carcass ply with steel cords having filaments with diameters from 0.10 mm to 0.12 mm.
